(19) United States
(12) Patent Application Publication
(10) Pub. No.: US 2011/0000802 A1
(43) Pub. Date: Jan. 6, 2011

(54) TACTILE PACKAGING FOR CONSUMER GOODS

(75) Inventors: Jacques Weiss, Vufflens la Ville (CH); Jacques Mermod, Epalinges (CH); Virginy Suchet, Vevey (CH)

Correspondence Address: BUCHANAN, INGERSOLL & ROONEY PC, POST OFFICE BOX 1404, ALEXANDRIA, VA, 22313-1404, US

(73) Assignee: Philip Morris USA Inc., Richmond, VA (US)

(21) Appl. No.: 12/828,965

(22) Filed: Jul. 1, 2010

(30) Foreign Application Priority Data
Jul. 1, 2009 (IB) PCT/IB2009/006319

(51) Int. Cl. A24F 15/00; B32B 33/00; B05D 1/36; B31B 1/26

(52) U.S. Cl. 206/242; 428/195.1; 427/265; 493/405

(57) ABSTRACT

Packaging for consumer goods having a discontinuous tactile coating is provided. The discontinuous tactile coating is formed by applying one or more varnishes to the outer surface of the packaging in a pattern comprising a plurality of raised features having a height of at least about 10 microns and a separation of at least about 20 microns. The one or more varnishes can include one or more tinted varnishes.

### CROSS-REFERENCE TO RELATED APPLICATION

This application corresponds and claims priority to International Patent Application No. PCT/IB2009/006319, filed Jul. 1, 2009, the entire content of which is incorporated herein by this reference thereto.

### BACKGROUND

Smoking articles and other consumer goods are commonly packaged in containers formed from one or more folded laminar blanks of paper, board or other sheet material. Prior to being folded around a wrapped bundle of smoking articles in order to form the container, the outer surfaces of the one or more laminar blanks that form the exterior of the container are typically printed, embossed, debossed or otherwise embellished with graphics and/or text, such as manufacturer or brand logos, trade marks, slogans and other manufacturer, product and/or promotional information.

It is known to coat the printed surfaces of packaging for consumer goods with ultraviolet varnishes. In one known embodiment, an ultraviolet varnish is applied all over the printed surface as a continuous coating (all-over or flood varnish). In another known embodiment, an ultraviolet varnish is applied to selected areas or spots of the printed surface (spot varnish). Typically, transparent colorless high gloss ultraviolet varnishes are used to coat the printed surfaces of packaging for consumer goods in order to produce shiny reflective coatings.

It would be desirable to provide packaging for consumer goods having a texture on the outer surface that affords a tactile sensation to a consumer when they handle the packaging.

The present invention relates to packaging for consumer goods having a discontinuous tactile coating.

The packaging of many consumer goods is discarded by consumers shortly after purchase. In contrast, consumers typically do not discard containers of cigarettes and other smoking articles until their contents have been consumed. Therefore, it would be particularly desirable to provide a container of smoking articles having a durable texture on the outer surface that affords a tactile sensation to a consumer each time they handle the container.

### SUMMARY

Packaging for consumer goods having a discontinuous tactile coating is provided. The discontinuous tactile coating includes one or more varnishes applied to an outer surface of the packaging in a pattern. In a preferred embodiment, the pattern includes a plurality of raised features having a height of at least about 10 microns and a separation of at least about 20 microns. Preferably, the plurality of raised features are of substantially the same height. Also preferably, the discontinuous tactile coating overlies graphics, text or a combination thereof printed on the outer surface of the packaging. Moreover, the discontinuous tactile coating may include one or more tinted varnishes applied to the outer surface of the packaging. In the preferred embodiment, the discontinuous tactile coating has a coefficient of static friction ranging from about 0.2 to about 1.0.

In the preferred embodiment, the packaging may be formed from one or more folded laminar blanks. Preferably, the one or more folded laminar board blanks have a weight ranging from about 60 grams per square meter (“gsm”) to about 250 grams per square meter.

A container of smoking articles can include the packaging for consumer goods having a discontinuous tactile coating.

In another embodiment, a method of making packaging for consumer goods having a discontinuous tactile coating includes applying one or more varnishes to the outer surface of a laminar blank in a pattern including a plurality of raised features having a height of at least about 10 microns and a separation of at least about 20 microns, and curing the one or more varnishes. Preferably, the method also includes curing the one or more varnishes in an inert gas atmosphere. Also preferably, the method includes folding the laminar blank around a bundle of smoking articles.

### BRIEF DESCRIPTION OF THE DRAWINGS

The tactile packaging will be further described, by way of example only, with reference to the accompanying drawings.

FIG. 1 shows a perspective view of a hinge-lid container of smoking articles having a discontinuous tactile coating formed by applying a tinted varnish to the front wall of the hinged lid pack in a regular striped pattern; and

FIGS. 2(a) to (f) show examples of regular and irregular patterns in which one or more varnishes may be applied to the outer surface of packaging for consumer goods.

### DETAILED DESCRIPTION

In a preferred embodiment, packaging for consumer goods having a discontinuous tactile coating includes a discontinuous tactile coating formed by applying one or more varnishes to the outer surface of the packaging in a pattern including a plurality of raised features having a height of at least about 10 microns and a separation of at least about 20 microns.

Throughout the specification, the term ‘varnish’ is used to denote a liquid coating that solidifies upon curing.

Throughout the specification, the term ‘height’ is used to denote the extent of the plurality of raised features in a direction perpendicular to the generally planar outer surface of the packaging.

Throughout the specification, the term ‘separation’ is used to denote the distance between the peaks of adjacent raised features within the pattern generally in a direction substantially parallel to the plane of the packaging outer surface.

Preferably, the plurality of raised features have a height ranging from about 10 microns to about 500 microns, more preferably ranging from about 10 microns to about 100 microns.

Also preferably, the discontinuous tactile coating may be formed by applying one or more varnishes to the outer surface of the packaging in a pattern including a plurality of raised features of the same or different heights. Preferably, the plurality of raised features are of substantially the same height. Also preferably, the plurality of features have a separation ranging from about 20 microns to about 10 cm, more preferably ranging from about 20 microns to about 1 cm, and most preferably ranging from about 20 microns to about 0.1 cm.

In the preferred embodiment, the plurality of raised features formed by application of one or more varnishes to the outer surface of packaging for consumer goods advantageously provide the packaging with a novel, durable, non-abrasive, texture that affords a tactile sensation to consumers when handling the packaging during use.

Preferably, the discontinuous tactile coating has a coefficient of static friction ranging from about 0.2 to about 1.0, more preferably ranging from about 0.25 to about 0.75, and most preferably ranging from about 0.3 to about 0.5.

Also preferably, the discontinuous tactile coating may be formed by applying the one or more varnishes to the outer surface of the packaging in any pattern including a plurality of raised features.

In the preferred embodiment, the discontinuous tactile coating is formed by applying the one or more varnishes to the outer surface of the packaging in a regular pattern. Throughout the specification, the term ‘regular pattern’ is used to denote a pattern including a regular array of raised features. For example, the one or more varnishes may be applied to the outer surface of the packaging in a regular striped pattern, a regular checked or square pattern, a regular brick pattern, a regular dotted or spotted pattern, a regular honeycomb or hexagonal pattern or any other regular alphanumeric, pictographic or geometric pattern.

In another embodiment, the discontinuous tactile coating is formed by applying the one or more varnishes to the outer surface of the packaging in an irregular pattern. Throughout the specification, the term ‘irregular pattern’ is used to denote a pattern including a non-repetitive or random array of raised features. For example, the one or more varnishes may be applied to the outer surface of the packaging in an irregular ripple or wave pattern, an irregular swirl pattern, an irregular spiral pattern, an irregular whorl pattern, an irregular wood grain pattern, an irregular tire tread pattern or irregular animal skin patterns (for example, cow, zebra, tiger, leopard, snake, alligator or crocodile skin patterns).

Preferably, the pattern includes a plurality of discrete raised features.

By applying one or more varnishes to substantially the entire outer surface of the packaging in a pattern including a plurality of raised features, packaging for consumer goods according to the invention may be provided with a discontinuous tactile coating on substantially the entire exterior of the packaging. Alternatively, by applying one or more varnishes to only a portion of the outer surface of the packaging in a pattern including a plurality of raised features, packaging for consumer goods may be provided with a discontinuous tactile coating on only a portion of the exterior of the packaging.

In the preferred embodiment, the pattern may include a concentration gradient or distribution of the one or more varnishes per unit area of the outer surface of the packaging. For example, a concentration gradient of the one or more varnishes within the pattern can vary between a first portion having a low concentration and a second portion having a high concentration.

Preferably, a concentration gradient may be achieved by varying the surface area of the pattern (for example, by increasing the size of geometric features or the font size of alphanumeric features of the pattern). Alternatively or in addition, a concentration gradient may be achieved by varying the height of the raised features in the pattern.

Also preferably, the discontinuous tactile coating is provided on a portion of the outer surface of the packaging that is printed with a design including graphics, text or a combination of the two. For example, the discontinuous tactile coating may be formed by applying one or more varnishes to a portion of the outer surface of the packaging that is printed with manufacturer or brand logos, trade marks, slogans or other advertising, promotional or product information. Alternatively or in addition, the discontinuous tactile coating may be provided on an unprinted or plain portion of the outer surface of the packaging.

Where the discontinuous tactile coating is provided on a portion of the outer surface of the packaging that is printed with a design, the discontinuous tactile coating may be formed by applying the one or more varnishes to the outer surface of the packaging in a pattern corresponding to one or more features of the printed design. This advantageously has the effect of highlighting the features of the printed design corresponding to the pattern. For example, the discontinuous tactile coating may be formed by applying the one or more varnishes to the outer surface of the packaging in a pattern corresponding to a manufacturer or brand logo printed on the outer surface.

In the preferred embodiment, the discontinuous tactile coating is formed by applying one or more tinted varnishes to the outer surface of the packaging.

As well as providing a novel texture that affords a tactile sensation, the application of one or more tinted varnishes to the outer surface of packaging for consumer goods advantageously provides the exterior of the packaging with a novel appearance. Throughout the specification, the term ‘tinted varnish’ is used to denote a varnish including at least one tinting agent selected from the group consisting of pigments, dyes and matt agents. The at least one tinting agent may affect one or both of the color and opacity of the tinted varnish.

Preferably, the discontinuous tactile coating may be formed by applying two or more tinted varnishes of the same or different color to the outer surface of the packaging.

Alternatively or in addition, the discontinuous tactile coating may be formed by applying two or more tinted varnishes of the same or different opacity to the outer surface of the packaging.

Where the discontinuous tactile coating is provided on a portion of the outer surface of the packaging that is printed with a design, the discontinuous tactile coating may be formed by applying one or more tinted varnishes of the same or different color to the design to the outer surface of the packaging.

In the preferred embodiment, matt agents may be present in the one or more tinted varnishes in an amount of, for example, up to about 50% by weight of the tinted varnish.

Preferably, pigments and dyes may be present in the one or more tinted varnishes in an amount of, for example, between about 1% and about 45% by weight of the tinted varnish, preferably of between about 10% and about 20% by weight of the tinted varnish.

Also preferably, the tinting range of the one or more tinted varnishes may be from about 0.5% to about 100%.

Moreover, the one or more tinted varnishes may include any suitable pigments, dyes or matt agents or suitable combinations of pigments, dyes and matt agents. For example, the one or more tinted varnishes may include organic pigments.

In the preferred embodiment, the packaging may be formed from any suitable material or combinations of materials, provided that at least a portion of the outer surface thereof is formed from a material or combination of materials to which a varnish may be applied. Suitable materials include, but are not limited to, paper, board (for example, paperboard, cardboard or carton board), laminated board (for example, film laminated board or, foil laminated board), plastic, metal and combinations thereof.

Preferably, the packaging is formed from board. More preferably, the packaging is formed from board having a weight ranging from about 50 gsm to about 350 gsm. Most preferably, the packaging is formed from board having a weight ranging from about 60 gsm to about 250 gsm.

Preferably, the packaging is formed from one or more folded laminar blanks, more preferably from one or more folded laminar board blanks. The discontinuous coating may be formed by applying the one or more varnishes to the outer surface of the packaging in any suitable manner. For example, the one or more varnishes may be applied by gravure or rotogravure printing, flexographic printing, lithographic printing, offset printing or screen printing.

Also preferably, the one or more varnishes may be applied to the outer surface after assembly of the packaging. Alternatively, the one or more varnishes may be applied to one or more components or materials from which the packaging is formed at any point prior to or during assembly of the packaging. Preferably, the one or more varnishes are applied to one or more laminar blanks from which the packaging is subsequently formed, more preferably to one or more pre-printed laminar board blanks from which the packaging is subsequently formed.

After the application of the one or more varnishes thereto in a pattern including a plurality of raised features, the one or more laminar blanks may be folded to form the packaging. For example, the one or more laminar blanks may advantageously be folded around a wrapped bundle of smoking articles to form a container of smoking articles using known and available machinery and methods employed in the production of prior art packs and cartons of smoking articles.

Where the discontinuous coating is formed by applying two or more varnishes to the outer surface of the packaging in a pattern including a plurality of raised features, the two or more varnishes may be applied simultaneously or successively.

For example, the discontinuous tactile coating may be formed by applying two or more varnishes to the outer surface of the packaging using a single roller or cylinder in successive applications, wherein a different one of the two or more varnishes is applied in each step. Alternatively, the discontinuous tactile coating may be formed by applying two or more varnishes to the outer surface of the packaging using multiple rollers or cylinders wherein each roller or cylinder applies a separate one of the two or more varnishes.

Having been applied to the outer surface of the packaging in a pattern including a plurality of raised features, the one or more varnishes may be cured in any suitable known manner to form the discontinuous tactile coating.

In a preferred embodiment, the one or more varnishes are cured in an inert gas atmosphere. For example, the one or more varnishes may be cured under a nitrogen or carbon dioxide atmosphere.

Alternatively or in addition, the one or more varnishes may be cured in other known manners. For example, the one or more varnishes may be cured by exposure to ultraviolet light.

Suitable varnishes for use in the present invention are known in the art and commercially available from, for example, Schmid Rhyner AG of Adliswil, Switzerland.

Preferably, packaging may be used for a variety of consumer goods. In the preferred embodiment, packaging is used for smoking articles.

A container of smoking articles including packaging is also provided herein.

In a preferred embodiment, containers of smoking articles may be individual packs of smoking articles or cartons including a plurality of individual packs of smoking articles.

Where, containers of smoking articles are individual packs of smoking articles they may have substantially the same construction as known packs of smoking articles including, but not limited to, hinge-lid packs, slide and shell packs, shoulder packs and booklet packs. Similarly, where containers of smoking articles according to the invention are cartons including a plurality of individual packets of smoking articles they may have substantially the same construction as known cartons of smoking articles.

Preferably, containers of smoking articles may be ‘hard’ packs. For example, containers may be rigid, hinge-lid containers including a box portion and a lid portion connected to the box portion along a hinge line extending across the rear wall of the container. In such embodiments, the discontinuous tactile coating may be provided on the exterior of one or both of the box portion and the lid portion.

Alternatively, containers of smoking articles may be rigid slide and shell containers having an outer shell and an inner slide or tray in which the smoking articles are housed and which is slidable within the outer shell. In such embodiments, the discontinuous tactile coating may be provided on the exterior of the outer shell or on the exterior of the outer shell and inner slide of the rigid slide and shell container.

In yet another embodiment, containers of smoking articles may be ‘soft’ packs including a cup-shaped box containing a wrapped bundle of smoking articles.

Preferably, containers of smoking articles may have one or more right-angled longitudinal edges, one or more right-angled transverse edges, one or more rounded longitudinal edges, one or more rounded transverse edges, one or more bevelled longitudinal edges, one or more bevelled transverse edges, or any suitable combination thereof. For example, by scoring in a known manner one or more laminar blanks from which the containers are produced, ‘rounded-corner’ and ‘bevelled-corner’ containers of smoking according to the invention may be produced.

Also preferably, containers of smoking articles may advantageously house smoking articles including, but not limited to, conventional lit-end cigarettes, cigars or cigarillos, heated smoking articles including a combustible fuel element or heat source and an aerosol-generating substrate (for example cigarettes of the type disclosed in U.S. Pat. No. 4,714,082, the entire content of which is incorporated herein by reference thereto) and smoking articles for use with electrical smoking systems (for example cigarettes of the type disclosed in U.S. Pat. No. 5,692,525, the entire content of which is incorporated herein by reference thereto).

It will be appreciated that through an appropriate choice of the dimensions of the packaging, containers of smoking articles may house different total numbers of smoking articles or different arrangements of smoking articles. For example, containers may house a total of between ten and thirty smoking articles.

In the preferred embodiment, the smoking articles may be arranged in different collations, depending on the total number of smoking articles. For example, the smoking articles may be arranged in a single row of six, seven, eight, nine or ten. Alternatively, the smoking articles may be arranged in two or more rows. The two or more rows may contain the same number of smoking articles. For example, the smoking articles may be arranged in: two rows of five, six, seven, eight, nine or ten; three rows of five or seven; or four rows of four, five or six. Alternatively, the two or more rows may include at least two rows containing different numbers of smoking articles to each other. For example, the smoking articles may be arranged in: a row of five and a row of six (5-6); a row of six and a row of seven (6-7); a row of seven and a row of eight (7-8); a middle row of five and two outer rows of six (6-5-6); a middle row of five and two outer rows of seven (7-5-7); a middle row of six and two outer rows of five (5-6-5); a middle row of six and two outer rows of seven (7-6-7); a middle row of seven and two outer rows of six (6-7-6); a middle row of nine and two outer rows of eight (8-9-8); or a middle row of six with one outer row of five and one outer row of seven (5-6-7).

Alternatively or in addition, containers of smoking articles may house smoking articles of different dimensions (for example, smoking articles of different length or different circumference). For example, the container may house smoking articles with lengths ranging from about 40 mm to about 180 mm and diameters ranging from about 4 mm to about 9 mm.

In the preferred embodiment, containers of smoking articles may house filterless smoking articles and smoking articles with various filter tips. In addition, containers of smoking articles may house smoking articles of the same type or brand, or of different types or brands (for example, smoking articles with different filters, tobacco blends, flavours, total particulate matter delivery, resistance to draw or nicotine delivery). Preferably, the dimensions of the container are adapted to the length of smoking articles, and the collation of the smoking articles housed therein. Typically, the external dimensions of the container range from about 0.5 mm to about 5 mm larger than the dimensions of the bundle or bundles of smoking articles housed therein.

Preferably, containers of smoking articles house a plurality of smoking articles wrapped in an inner liner of, for example, metal foil or metallized paper.

Also preferably, containers of smoking articles may be overwrapped in a known manner with any suitable known material or combination of materials including, but not limited to, cellophane, polymeric films of, for example, polyethylene or polypropylene, metallized polymeric films and laminated polymeric films. Preferably, containers of smoking articles may be overwrapped with overwrappers including one or more tear tapes. In the preferred embodiment, the one or more tear tapes may extend in a transverse or longitudinal direction around the perimeter of the container.

A method of making packaging for consumer goods having a discontinuous tactile coating, includes: applying one or more varnishes to the outer surface of a laminar blank in a pattern including a plurality of raised features having a height of at least about 10 microns and a separation of at least about 20 microns; and curing the one or more varnishes.

Preferably, the method includes curing the one or more varnishes in an inert gas atmosphere. For example, the method may include curing the one or more varnishes in a nitrogen or carbon dioxide atmosphere.

In a preferred embodiment, the method also includes: folding the laminar blank around a bundle of smoking articles.

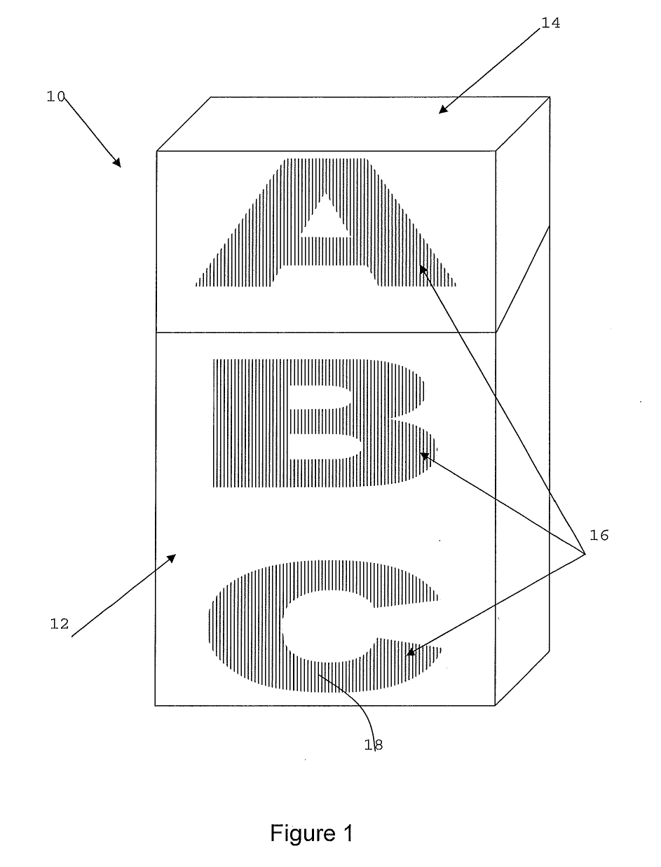

As shown in FIG. 1, the hinge-lid container 10 of smoking articles generally includes a lower box portion 12 and an upper lid portion 14, which is hinged to the lower box portion 12 along a horizontal hinge line that extends across the rear of the hinge-lid container 10. Preferably, the lower box portion 12 and the upper lid portion 14 have the same general construction as the box portion and the lid portion of a conventional hinge-lid cigarette pack having right-angled vertical edges and right-angled horizontal edges. Also preferably, the lower box portion 12 and upper lid portion 14 are formed from a single, folded, one-piece, laminar board blank.

In the following description of the hinge-lid container the terms “upper” and “top”, “bottom” and “lower” and “front” and “rear”, are used to describe the relative positions of components of the hinge-lid container when the container is held in an upright position by a consumer during opening so that the smoking articles in the container may be removed through the top side of the open container. These terms are used irrespective of the actual orientation of the hinge-lid container.

In the preferred embodiment, the lower box portion 12 has a front wall, a right side wall, a left side wall, a rear wall and a bottom wall. The upper lid portion 14 similarly has a front wall, a right side wall, a left side wall a and a rear wall, which function respectively as continuations of the corresponding walls of the lower box portion 12 when the box portion 12 and lid portion 14 are in the closed position shown in FIG. 1. Preferably, the upper lid portion 14 of the hinge-lid container 10 further includes a top wall, which opposes the bottom wall of the lower box portion 12 when the upper lid portion 14 is in the closed position shown in FIG. 1. Also preferably, the front walls of the box portion 12 and lid portion 14 of the hinge-lid container 10 are printed with manufacturer, product and promotional information represented schematically in FIG. 1 by solid-colored letters A, B and C.

Also in the preferred embodiment, a discontinuous tactile coating 16 is provided on the portions of the exterior of the hinge-lid container 10 printed with the manufacturer, product and promotional information. As shown in FIG. 1, the discontinuous tactile coating 16 is formed by the application of a tinted varnish 18 to the printed portions of the outer surface of the front walls of the box portion 12 and lid portion 14 of the hinge-lid container 10 in a regular vertical striped pattern.

In an alternative embodiment (not shown), the hinge-lid container of FIG. 1 is provided with a discontinuous tactile coating by applying the tinted varnish in a regular vertical striped pattern to the entire outer surface of the front walls of the box portion 12 and lid portion 14.

While the invention has been exemplified above with respect to a hinge-lid container having a discontinuous tactile coating on the outer surface of a single wall, it will be appreciated that containers of smoking articles may have discontinuous coatings provided on the outer surface of two or more walls of the container. For example, in a further embodiment (not shown), the entire exterior of the hinge-lid container of FIG. 1 is provided with a discontinuous tactile coating by applying a tinted varnish in a regular vertical striped pattern to the entire outer surface of the front, right side, left side, rear and bottom walls of the box portion 12 and the entire outer surface of the front, right side, left side, rear and top walls of the lid portion 14.

Furthermore, it will be appreciated that packaging for consumer goods may have a discontinuous coating that is formed by applying one or more varnishes to the outer surface of the packaging in two or more different patterns each of which includes a plurality of raised features. For example, in other embodiments (not shown), the hinge-lid container of FIG. 1 is provided with a discontinuous tactile coating by applying a tinted varnish in: (i) an irregular whorl pattern to the entire outer surface of the front walls of the box 12 and lid 14 portions; and (ii) in a regular vertical striped pattern to the entire outer surface of the rear walls of the box 12 and lid 14 portions.

While the invention has been exemplified above with respect to a container of smoking articles having a discontinuous tactile coating formed by applying a tinted varnish to portions of the outer surface of the front walls of the box portion 12 and lid portion 14 in a regular striped pattern, it will be appreciated that packaging for consumer goods according to the invention may have a discontinuous coating that is formed by applying one or more varnishes to the outer surface of the packaging in other regular or irregular patterns.

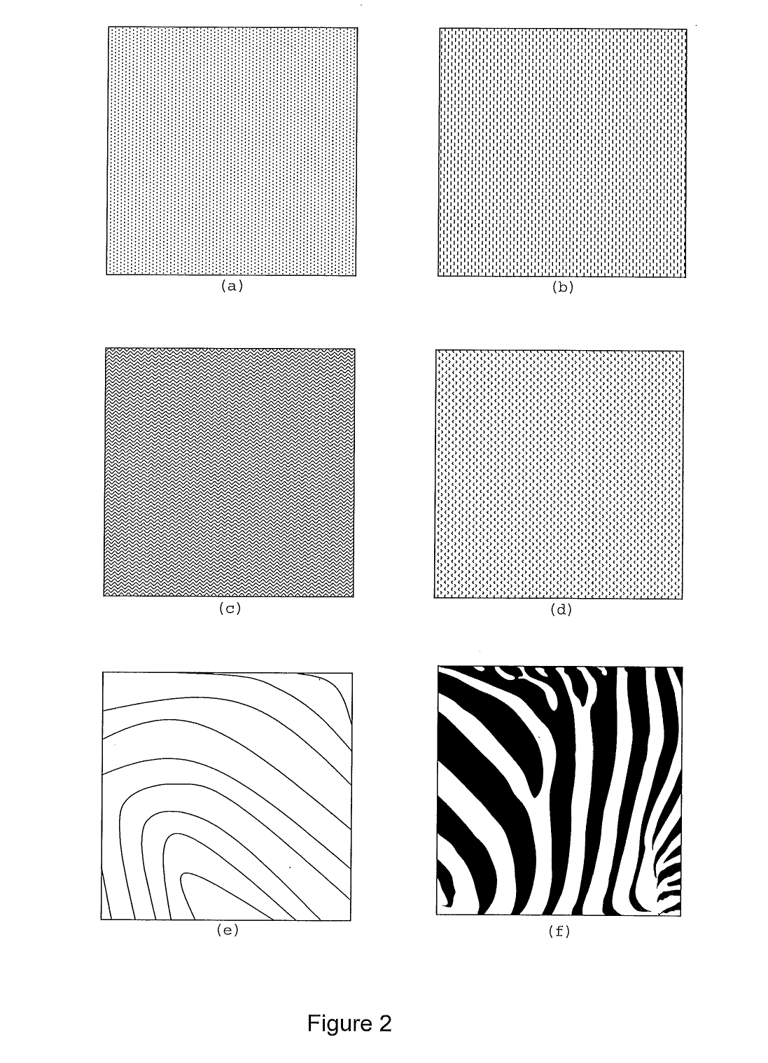

Examples of other regular patterns in which one or more varnishes may be applied to the outer surface of packaging for consumer goods according to the invention in order to form a discontinuous tactile coating are shown in FIGS. 2a to 2d. As shown in FIG. 2a, the varnishes may be applied in a regular dot pattern. As shown in FIG. 2b, the varnishes may be applied in a regular dash pattern, wherein adjacent lines of dashes may be offset. As shown in FIG. 2c, the varnishes may be applied in a regular wave pattern, wherein adjacent lines may be parallel to one another. As shown in FIG. 2d, the varnishes may be applied as chevrons arranged in a line in a regular pattern, wherein the chevrons may be applied in alternating directions and adjacent lines of chevrons may be offset from one another.

Examples of irregular patterns in which one or more varnishes may be applied to the outer surface of packaging for consumer goods according to the invention in order to form a discontinuous tactile coating are shown in FIGS. 2e and 2f. As shown in FIG. 2e, the varnishes may be applied in an irregular fine line pattern, such as an irregular wood grain pattern. As shown in FIG. 2f, the varnishes may be applied in an irregular pattern in which wide printed bands are separated by wide spaces. The wide printed bands may resemble animal skin prints, such as a zebra skin pattern.

Furthermore, it will be appreciated that packaging for consumer goods may have a discontinuous coating that is formed by applying one or more non-tinted varnishes to the outer surface of the packaging.

In this specification, the word “about” is often used in connection with numerical values to indicate that mathematical precision of such values is not intended. Accordingly, it is intended that where “about” is used with a numerical value, a tolerance of ±10% is contemplated for that numerical value.

In this specification the words “generally” and “substantially” are sometimes used with respect to terms. When used with geometric terms, the words “generally” and “substantially” are intended to encompass not only features which meet the strict definitions but also features which fairly approximate the strict definitions.

While the foregoing describes in detail a preferred tactile packaging for consumer goods with reference to a specific embodiment thereof, it will be apparent to one skilled in the art that various changes and modifications may be made to the tactile packaging, which do not materially depart from the spirit and scope of the foregoing description. Accordingly, all such changes, modifications, and equivalents that fall within the spirit and scope of the appended claims are intended to be encompassed thereby.

We claim:

1. Packaging for consumer goods comprising a discontinuous tactile coating, wherein the discontinuous tactile coating includes one or more varnishes applied to an outer surface of the packaging in a pattern, said pattern including a plurality of raised features having a height of at least about 10 microns and a separation of at least about 20 microns.

2. The packaging of claim 1, wherein the plurality of raised features are of substantially the same height.

3. The packaging of claim 1, wherein the discontinuous tactile coating overlies graphics, text or a combination thereof printed on the outer surface of the packaging.

4. The packaging of claim 1, wherein the discontinuous tactile coating includes one or more tinted varnishes applied to the outer surface of the packaging.

5. The packaging of claim 1, wherein the discontinuous tactile coating has a coefficient of static friction ranging from about 0.2 to about 1.0.

6. The packaging of claim 1 formed from one or more folded laminar blanks.

7. The packaging of claim 6, wherein the one or more folded laminar board blanks have a weight ranging from about 60 grams per square meter to about 250 grams per square meter.

8. A container of smoking articles comprising packaging of claim 1.

9. A method of making packaging for consumer goods having a discontinuous tactile coating, the method comprising:
applying one or more varnishes to the outer surface of a laminar blank in a pattern comprising a plurality of raised features having a height of at least about 10 microns and a separation of at least about 20 microns; and
curing the one or more varnishes.

10. The method of claim 9, further including curing the one or more varnishes in an inert gas atmosphere.

11. The method of claim 9, further including folding the laminar blank around a bundle of smoking articles.
